(19) United States
(12) Patent Application Publication
(10) Pub. No.: US 2005/0276587 A1
(43) Pub. Date: Dec. 15, 2005

(54) Portable image capture, display and printing system

(76) Inventor: Yefim Massarsky, Newton, MA (US)

Correspondence Address: MIRICK O'CONNELL, 1700 WEST PARK DRIVE, WESTBOROUGH, MA, 01581-3941, US

(21) Appl. No.: 10/411,064

(22) Filed: Apr. 10, 2003

Related U.S. Application Data
(60) Provisional application No. 60/372,900, filed on Apr. 16, 2002.

(51) Int. Cl. G03B 15/00

(52) U.S. Cl. 396/1

(57) ABSTRACT

A portable image capture, display and printing system. The system includes an image acquisition device such as a video camera, and a display monitor. A general purpose computer is used to save and process the acquired image, move an icon about the display monitor, and create on the monitor a display of the image. The displayed image is created gradually, along the path on the display of the icon. The system also includes a printer for printing the displayed image. At least the video camera and the monitor are mounted in a first portable, collapsible support structure that preferably looks like an artist's easel.

### CROSS REFERENCE TO RELATED APPLICATION

This application claims priority of Provisional application Ser. No. 60/372,900, filed on Apr. 16, 2002.

### FIELD OF THE INVENTION

This invention relates to a fully-portable image capture, display and printing system that looks like an artist's easel.

### BACKGROUND OF THE INVENTION

A portable-image capture, display and printing system is described in U.S. Pat. No. 6,021,417. The embodiment of the system described in that invention is a self-photography booth. Although the system provides tremendous entertainment value and an attractive printed output, a photo booth is a relatively large, permanent, or semi-permanent structure. Accordingly, users must come to the system in order to experience the entertainment value associated with the system.

### SUMMARY OF THE INVENTION

It is an object of this invention to provide a portable image capture, display and printing system that preferably takes the form of an artist's easel. The easel structure is fully collapsible into a relatively small, portable package that can be moved by a single person and can be transported on airplanes and in motor vehicles. As a result, this system can be transported to users rather than the users having to come to the system. The entertainment value associated with the system makes it very attractive to use at social events. The system can be enabled to have varied functionality, particularly to provide different forms of image outputs.

This invention comprises a portable image capture, display and printing system. This system is used to capture a portrait of a user and create and then print a display that mimics the manner in which a portrait artist would capture the portrait of the user. This methodology and the means to accomplish it are described in U.S. Pat. No. 6,021,417, the disclosure of which is incorporate herein by reference.

This invention features a portable image capture, display and printing system, comprising: an image acquisition device (e.g., a video camera); a display monitor; and a general purpose computer for saving and processing the acquired image and creating on the monitor a display of the image. An icon (such as a hand holding a pencil or brush) is displayed on the monitor, and the displayed image is created along the path of the icon as it moves about the display device. There is also a printer for printing the displayed image. At least the image acquisition device and the monitor are mounted in a first portable support structure, which preferably looks like an artist's easel.

The portable image capture, display and printing system of the invention may further comprise a seat for a user that places the user in the field of view of the image capture device, wherein the seat comprises at least a portion of a separate, second portable structure. The portable image capture, display and printing system may still further comprise a portable background member that is capable of being removably held by the second portable structure such that is spans most or all of the field of view of the image capture device. The portable background member may comprise a flexible sheet member. The portable background member may further comprise a pair of poles that can be inserted into and removed from the second portable structure, wherein the flexible sheet member is held between the poles.

The computer and printer are preferably stored in the bench (the second portable structure) or a different structure. The portable image capture, display and printing system may further comprise a false floor member coupled to at least the first portable structure, to create a space for wiring to run between the computer and the monitor. The system may further comprise user system controls mounted on the first support structure. The system controls may alternatively be accomplished by wireless remote control.

The first support structure may comprise an easel. The first support structure may further comprise a stand on which the easel is mounted. The easel may comprise a front easel member that carries at least the imaging camera and the monitor, hingedly coupled to a second easel member, wherein the two easel members meet at an acute angle to form the easel. The easel may be hingedly coupled to the stand so that they can fold relative to one another.

In the invention, the entire device is made portable by assembling the components in a number of separable, portable support structures. This construction allows the system to be broken down into small portions that can be carried and moved in a station wagon or mini van and then set up for temporary use, for example, at social functions such as weddings and bar mitzvahs.

### BRIEF DESCRIPTION OF THE DRAWINGS

Other objects, features and advantages will occur to those skilled in the art from the following description of the preferred embodiments and the accompanying drawings in which:

FIG. 1 is a perspective view of the construction of one embodiment of the system of this invention;

FIG. 2 is a cross-sectional view of the first portable support structure of the system of FIG. 1;

FIGS. 3A and 3B detail one embodiment of a collapsible user seat of the system of FIG. 1;

FIGS. 4A and 4B are a back view, and a side cross-sectional view, respectively, of the seat carrying the computer and printer of the embodiment of FIG. 1;

FIGS. 5A and 5B are front and side cross-sectional views, respectively, of the computer and printer chest of an alternative embodiment; and

FIGS. 6A through 6D are a perspective view, a partial cross-sectional view, and two partial exploded views, respectfully, of another embodiment of this invention.

### DETAILED DESCRIPTION OF THE PREFERRED EMBODIMENTS

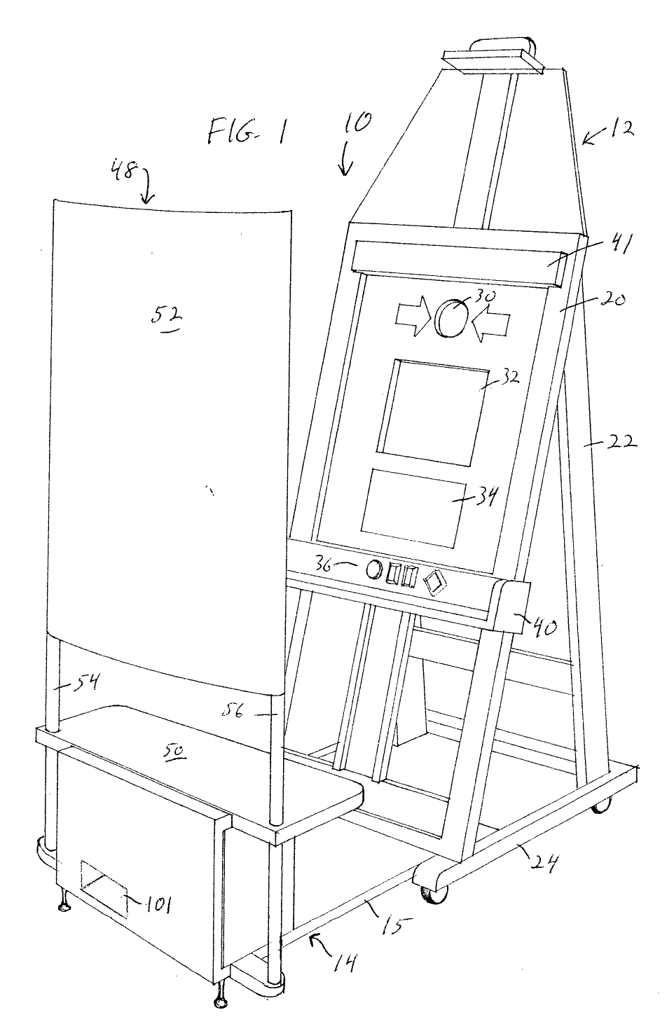

Portable image capture and display and printing system 10 of the first embodiment of this invention comprises first portable support structure 12 which, in this embodiment, has the appearance of an artist's easel. Because the system as a whole simulates the creation by an artist of a portrait, the construction in the form of an easel immediately conveys to the user an idea of what the system is, and also provides a more authentic look for the user and onlookers. The whole system can be folded into an easily-transportable flat package. System 10 also comprises second portable support structure 14 that includes user seat or bench 50. Portable background member 48 is the third major component of the system and is capable of being removably held by second portable structure 14 in the upright position shown in FIG. 1. The system further comprises an image acquisition device, which is preferably a video camera that is mounted such that its view is through opening 30 in front face 28 of front easel member 20. The acquired image is stored in the computer memory. Opening 32 is for the face of a flat screen monitor, and opening 34 is for a panel comprising some of the user controls and instructions for operating the system. Openings 36 in easel bottom tray 40 are for controls such as buttons and joysticks and other controls that can be used to allow the user to control the system and make the necessary selections. As described in the patent incorporated by reference herein, the system displays an icon. The icon may be an icon of a hand holding a brush or pencil. The icon is moved across the display screen. The image is created along the path of the icon as it moves across the screen, to simulate a drawing or painting being created by an artist.

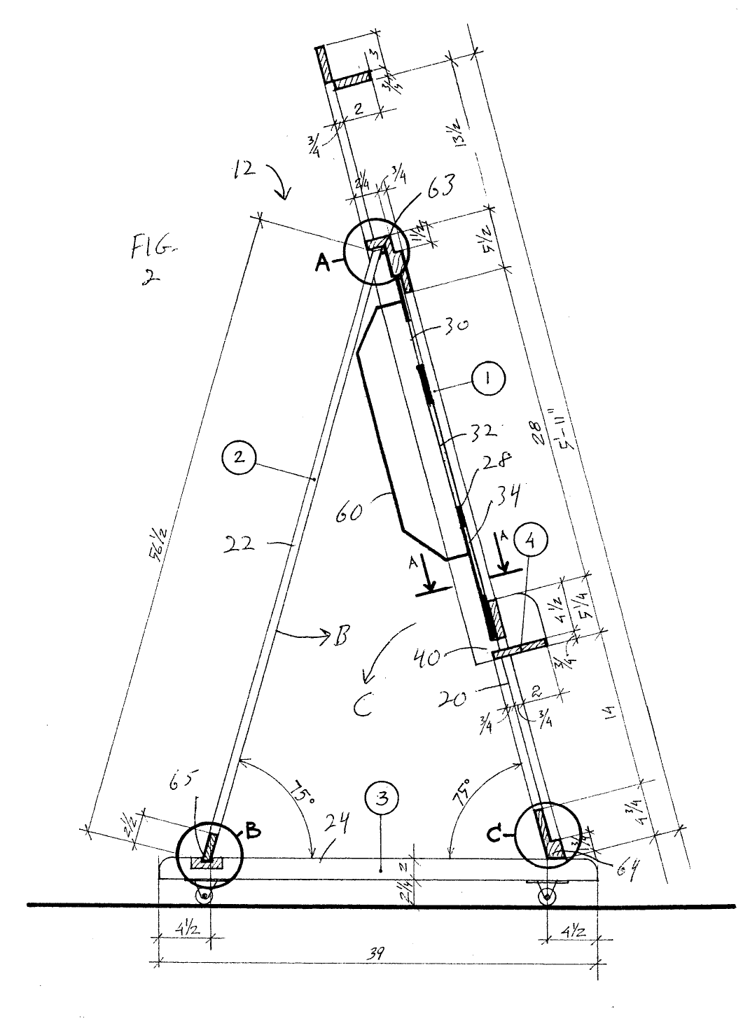

The construction of first portable support structure 12 is depicted in some detail in FIG. 2. Preferably, structure 12 is a wooden construction that mimics an artist's easel. Structure 12 comprises front easel member 20, second easel member 22, and wheeled easel stand 24. Preferably, there are hinges at junctures 63 and 64, and member 22 can be lifted out of stand 24. Since member 22 comprises an open frame, it can fold back in the direction of arrow B against member 20, and both members can then be folded down in the direction of arrow C against stand 24 so that the whole construction can be folded flat for storage and transportation, and then easily expanded to the use position shown in FIGS. 1 and 2.

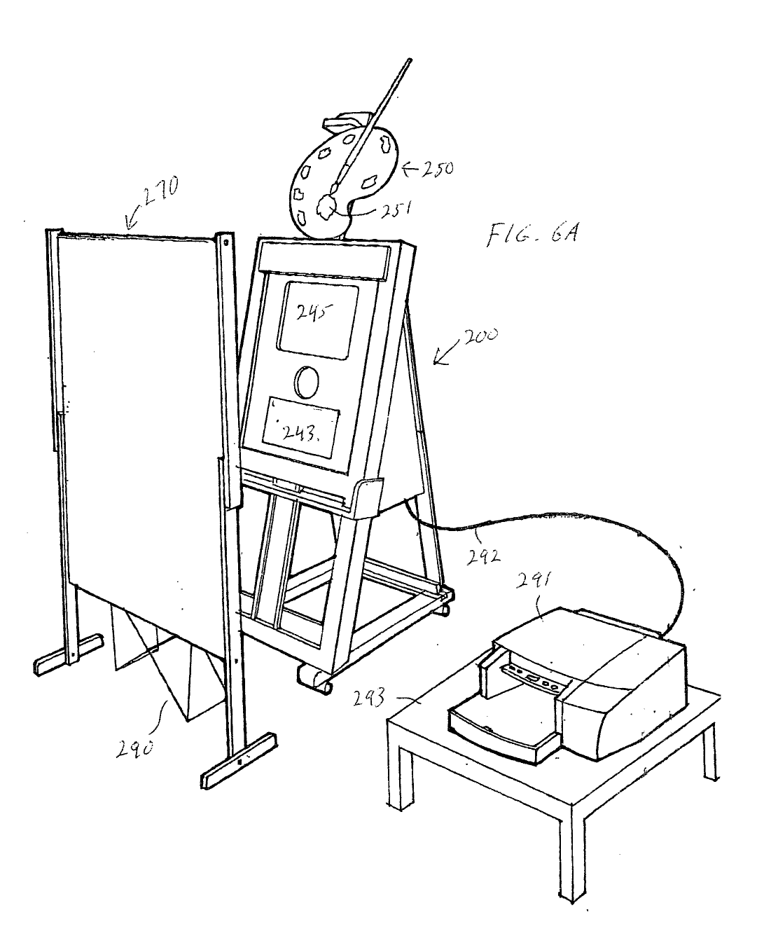

In one embodiment of the invention, FIG. 5A and 5B, the general purpose computer 90 and image printer 91 are carried in portable chest 70, and the necessary cabling is run between chest 70 and the components mounted in first portable support structure 12. In the preferred embodiment, the computer and the printer are mounted within the bench 50. In this case, the bench may not be collapsible. Bench 50 comprises both a seat and a storage compartment for the computer and printer, and bench 50 has opening 101 for the printer output tray 90. Alternatively, to provide better access to the printed output, the printer could be mounted on a shelf or another structure carried by first portable support structure 12.

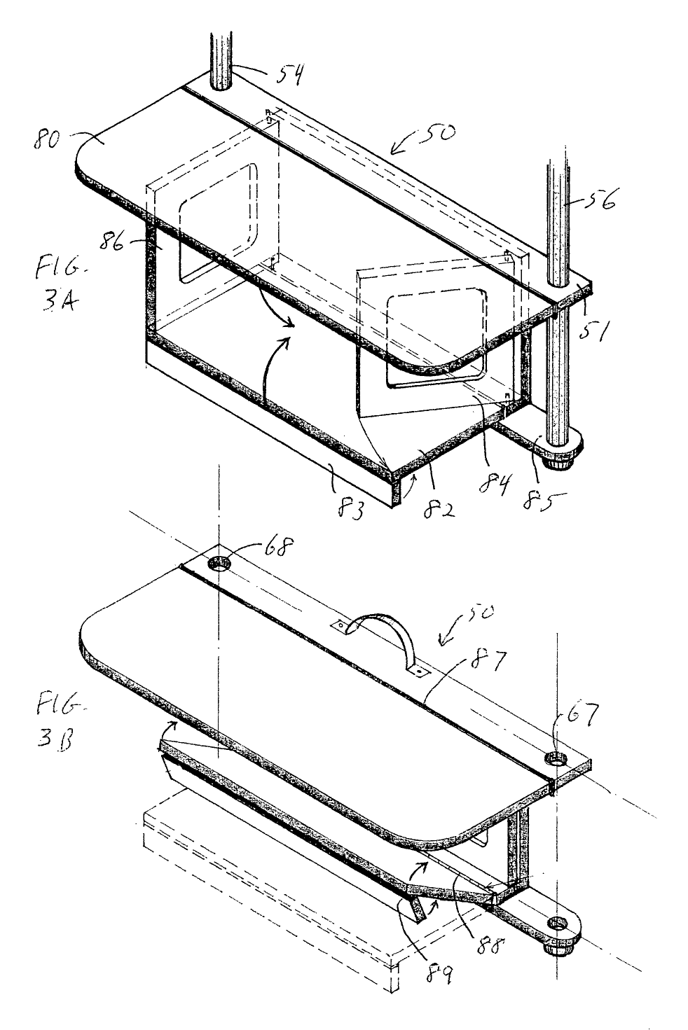

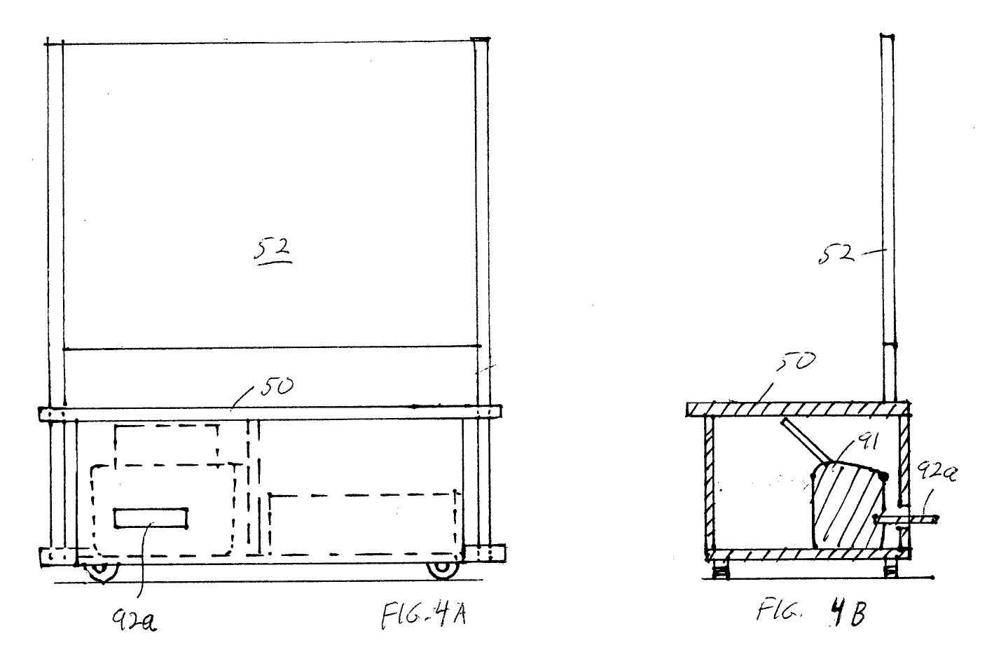

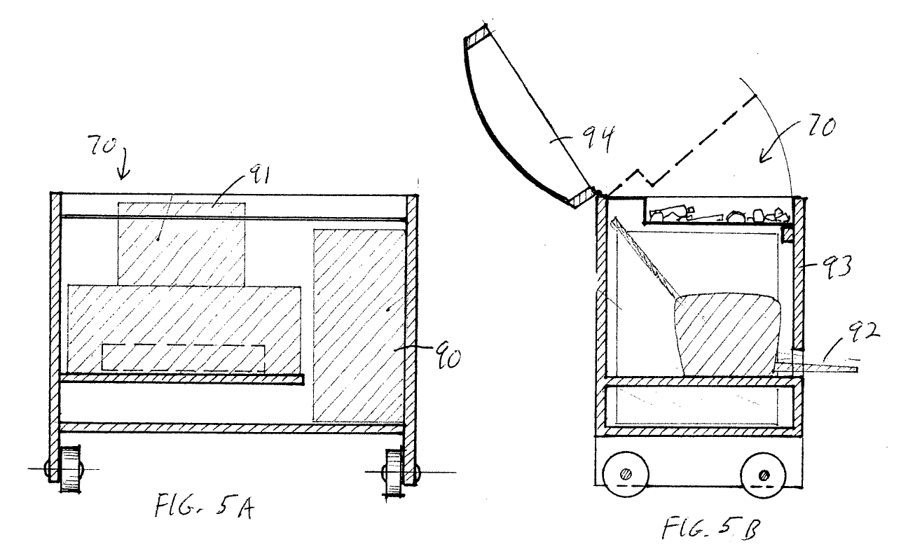

The collapsible bench construction and the construction of the computer and printer storage are shown in FIGS. 3-5. Seat 50 comprises seat top 80 that is hinged at meeting line 87 so that it can fold down to be stored. Seat top 80 is supported by hinged side members 84 and 86 that fold out in use, and fold in for storage. Seat bottom 82 with hinged seat bottom support leg 83 are hinged at meeting lines 88 and 89 so that they can fold up against the folded-in side members 84 and 86. Then seat top 80 can be folded down on those members to collapse the structure. As shown in the FIG. 3B, there can be a provision for a handle so that the entire seat 50 can be separately lifted and carried.

Also shown in this drawing is the preferred manner in which portable background member 48 is engaged with second portable support structure 14. That is, sets of openings 67 and 68 can be provided to accept support poles 54 and 56 that are thus held upright in use as shown in FIG. 1. Portable background member 52, which in this embodiment comprises a flexible sheet member, is attached to poles 54 and 56 and preferably spans the field of view of the video camera to provide a background for the user's image. When the system is broken down, poles 54 and 56 are lifted out, and member 52 is rolled over one or both poles to present a long, thin package that can be easily transported.

As shown in FIG. 1, false floor member 15 can be a part of one of members 12 or 14, or an entirely separable piece that can be slid into or otherwise removably coupled to both members 12 and 14. False floor member 15 is spaced an inch or so above the floor to both provide a surface for the user to stand on and rest his/her feet on, as well as provide any necessary space for running cables between members 12 and 14 in the embodiment in which the computer and/or printer are carried within seat 50.

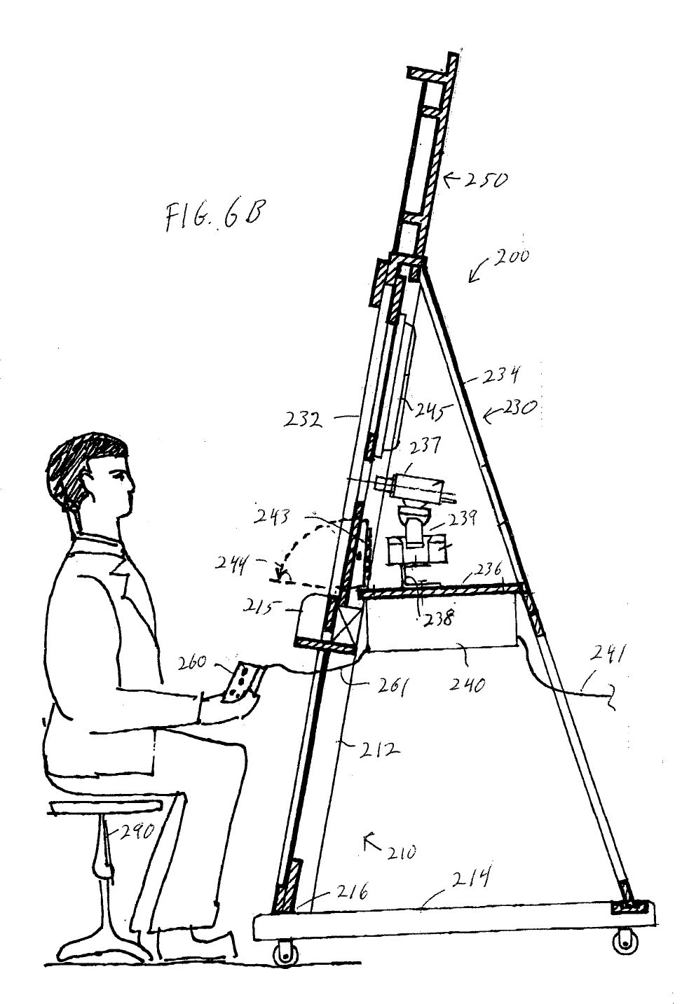

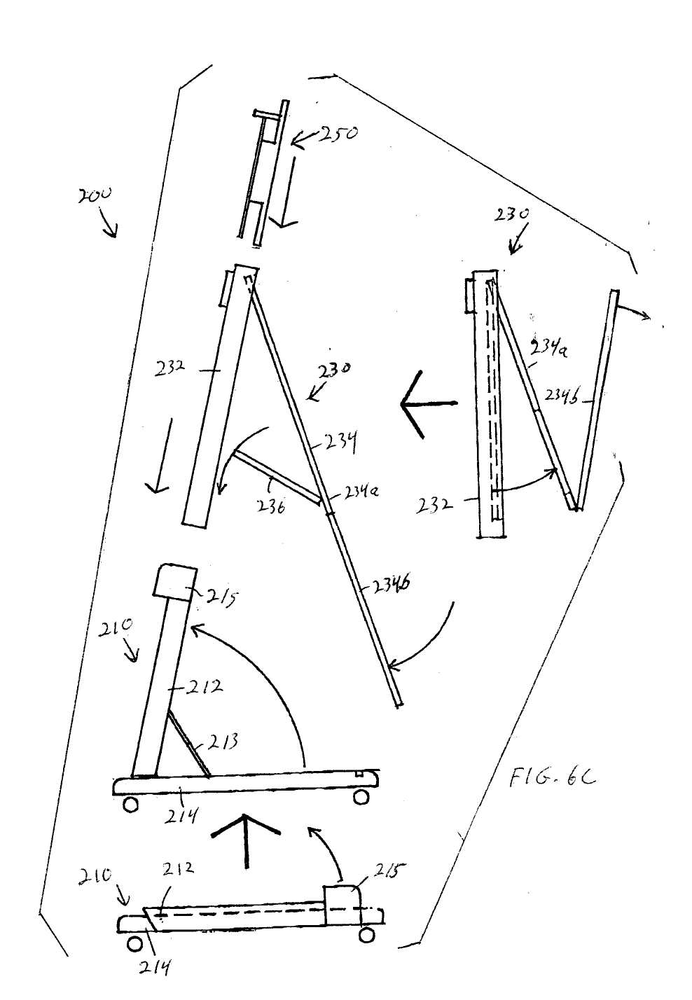

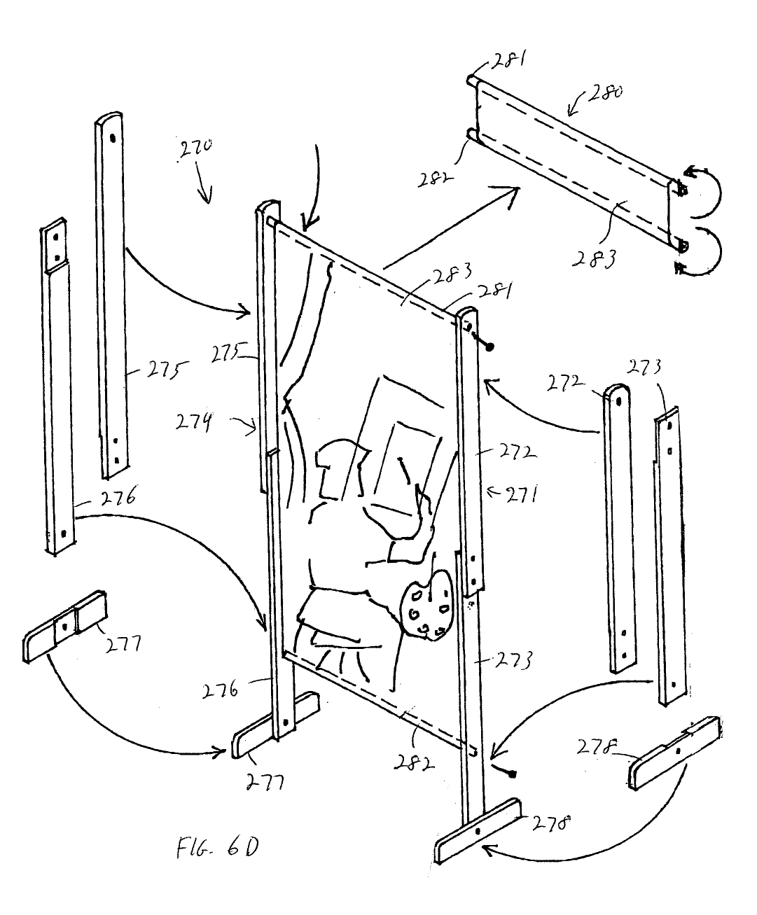

A second embodiment of the invention 200 is shown in FIGS. 6A through 6D. Embodiment 200 includes portable easel member 230, user seat 290, separate background member 270, and output printer 291 placed on table 293. Easel member 230 is shown in cross-sectional view in use in FIG. 6B, and the structural components of easel 230 are shown in an exploded view in FIG. 6C. Easel 200 defines three sections, sections 210, 230 and 250. Sections 210 and 230 are collapsible. Section 210 includes lower portion 212 of the front easel member and stand 214. Portion 212 is supported by collapsible support 213. These portions are hinged at point 216 so that portion 212 can collapse down onto portion 214. Section 230 includes upper portion 232 of the front of the easel to which back easel portion 234 is hinged. Support shelf 236 is hinged to member 234. Member 234 comprises upper member 234A that is hinged to lower member 234B so that the members can collapse as shown in the drawing. Upper decorative section 250 slides into the top of member 232. Section 250 may carry a structure that looks like an artist's pallet with area 251 that may comprise several different color lights to mimic the colors of a pallet. The lights may be displayed in sequence or in other fashions under control of computer 240, in which case there is a separable electrical cable connecting section 250 to computer 240. This easel arrangement allows the easel to be folded entirely flat into three relatively small pieces that can be packed in a case that can be carried by a person and transported in an airplane or motor vehicle. The interconnection of the sections can be accomplished with ACT use hardware such as allenhead screws or bolts.

In the assembled stage shown in FIG. 6B, shelf 236 is supported by the front easel member and carries fold-down T board support shelf 243 that can fold down to location 244 for access by a user. Preferably, this shelf is locked in the stowed position shown in FIG. 6B so that access is only allowed by the operator of the system. Video camera 237 can be fixed but is preferably operated under user control such as by remote control 260 so that the user can place his or her head and shoulders where desired in display 245. This can be accomplished with a two-dimensional panning device 239 that is carried on bracket 238 supported by shelf 236. Bracket 238 can be held to shelf 236 with removeable hardware, as can be panning device 239 or camera 237 directly to bracket 238. Cable 241 leads to a printer. The power cord is not shown.

Background section 270 is shown in exploded and assembled views in FIG. 6D. The structure comprises a stand that holds a flexible sheet. The stand comprises lower standing members 277 and 278 that support vertical members 274 and 271, respectfully. Member 274 comprises upper section 275 and lower section 276, and member 271 comprises upper section 272 and lower section 273. The sections are preferably easily taken apart such as depicted in the drawing by making the sections nesting and including appropriate easily removable interconnection hardware such as screws or bolts. Seat member 283 is rolled onto rods 281 and 282 that themselves are held in place by user removeable hardware. The backside of member 283 that is shown in the drawing can carry an illustrious graphic and the other side is typically blank to provide a background for the video camera.

The general purpose computer 240 accomplishes the saving and processing of acquired image, the movement of the icon about the display, and the gradual creation of the image, all is described in the patent incorporated by reference. Preferably, the computer is loaded with a number of distinct programs to provide varied entertainment to the users of the system. One could be described herein. Another could be a photo fantasy system in which the computer was loaded with a number of different background images into which the live image was placed. For example, the images could include a beach or cityscape, or be graphics such as “I love you” with a heart, etc. The system could also be enabled to print graphics that could be transferred to t-shirts, mugs and the likes, as is known in the art. Thus, the system can act as a portable video entertainment system.

Other embodiments will occur to those skilled in the art and are within the following claims:

1. A portable image capture, display and printing system, comprising:
an image acquisition device;
a display monitor;
means for saving and processing the acquired image;
means for moving an icon about the display monitor;
means for creating on the monitor a display of the image, wherein the displayed image is created gradually, along the path on the display of the icon; and
a printer for printing the displayed image;
wherein at least the image acquisition device and the monitor are mounted in a first portable, collapsible support structure.

2. The portable image capture, display and printing system of claim 1, further comprising a seat for a user that places the user in the field of view of the image capture device, wherein the seat comprises at least a portion of a separate, second portable structure.

3. The portable image capture, display and printing system of claim 2, further comprising a portable background member that is capable of being removably held by the second portable structure such that is spans most or all of the field of view of the image capture device.

4. The portable image capture, display and printing system of claim 3 wherein the portable background member comprises a flexible sheet member.

5. The portable image capture, display and printing system of claim 4 wherein the portable background member further comprises a pair of poles that can be inserted into and removed from the second portable structure, wherein the flexible sheet member is held between the poles.

6. The portable image capture, display and printing system of claim 2 wherein the computer and printer are stored in the seat.

7. The portable image capture, display and printing system of claim 1, further comprising a false floor member coupled to at least the first portable structure, to create a space for wiring to run between the computer and the monitor.

8. The portable image capture, display and printing system of claim 1 further comprising user system controls mounted to the first support structure.

9. The portable image capture, display and printing system of claim 1 further comprising user system controls accomplished by remote control.

10. The portable image capture, display and printing system of claim 1 wherein the first support structure comprises an easel.

11. The portable image capture, display and printing system of claim 10 wherein the first support structure further comprises a wheeled stand on which the easel is mounted.

12. The portable image capture, display and printing system of claim 10 wherein the easel comprises a front easel member that carries at least the imaging camera and the monitor, hingedly coupled to a second easel member, wherein the two easel members meet at an acute angle.

13. The portable image capture, display and printing system of claim 11 wherein the easel is hingedly coupled to the stand, so that they can fold relative to one another.

14. The portable image capture, display and printing system of claim 1 wherein the means for saving and processing the acquired image, the means for moving an icon about the display monitor, and the means for creating on the monitor a display of the image, are all accomplished with a computer with video processing capability.

15. The portable image capture, display and printing system of claim 14 wherein the computer and the printer are in a separate portable structure.

16. The portable image capture, display and printing system of claim 12 wherein the portable, collapsible support structure comprises at least two sections, each section being itself collapsible.

17. The portable image capture, display and printing system of claim 16 wherein one section includes a portion of the front easel member and the stand.

18. The portable image capture, display and printing system of claim 17 wherein another section includes another portion of the front easel member and the second easel member.

19. A portable image capture, display and printing system, comprising:
an image acquisition device;
a display monitor;
a general purpose computer for saving and processing the acquired image, moving an icon about the display monitor, and creating on the monitor a display of the image, wherein the displayed image is created gradually, along the path on the display of the icon; and
a printer for printing the displayed image;
wherein at least the image acquisition device and the monitor are mounted in a first portable, collapsible support structure that comprises an easel, defining at least two sections, each section being itself collapsible, one section including a portion of the front easel member and the stand, and another section including another portion of the front easel member and the second easel member.
